(19) United States
(12) Patent Application Publication
(10) Pub. No.: US 2017/0148406 A1
(43) Pub. Date: May 25, 2017

(54) DISPLAY PANELS AND THE DISPLAY DEVICES HAVING THE SAME

(71) Applicant: Shenzhen China Star Optoelectronics Technology Technology Co., Ltd., Shenzhen, Guangdong (CN)

(72) Inventor: Zhiguang YI, Shenzhen, Guangdong (CN)

(73) Assignee: Shenzhen China Star Optoelectronics Technology Technology Co., Ltd., Shenzhen, Guangdong (CN)

(21) Appl. No.: 14/888,172

(22) PCT Filed: Aug. 11, 2015
(86) PCT No.: PCT/CN2015/086663

§ 371 Date: Oct. 30, 2015

(30) Foreign Application Priority Data
Apr. 20, 2015 (CN) 201510187423.3

(51) Int. Cl. G09G 3/36; G02F 1/1362; G02F 1/1368

(52) U.S. Cl. CPC G09G 3/3677; G02F 1/1368; G02F 1/136286; G09G 2310/08; G09G 2310/0251; G09G 2300/0809; G02F 2203/64

(57) ABSTRACT

A display panel includes a plurality of pixel cells comprising thin film transistors (TFTs), wherein W representing a width of a trench within the TFT, and L representing a length of the trench within the TFT. A plurality of data lines and a plurality of scanning lines intersect with each other to limit locations of the pixel cells. A source driver connects to the data lines such that the data signals being provided to each of the data lines. A gate driver connects to the scanning lines such that scanning signals are provided to the scanning lines. Wherein a ratio (W/L) of the width (W) to the length (L) of the trench within the TFTs being configured such that the pixel cells connected by the same scanning line being fully charged at the same time.

### BACKGROUND OF THE INVENTION

1. Field of the Invention

The present disclosure relates to liquid crystal display technology, and more particularly to a display panel and a display device having the display panel.

2. Discussion of the Related Art

With respect to normal black LCDs, RC delay issues may exist such that the time periods for charging each of the pixel cells of each column to be full are different.

The RC delay may be smaller in a rim at one side of the gate IC, and which may be larger when being farther away from the gate IC. Thus, the pixel cells farther away from the gate IC may not be charged fully when the pixel cells in the rim at one side of the gate IC have been fully charged. In this way, in order to fully charge the pixel cells farther away from the gate IC, the pixel cells in the rim at one side of the gate IC may be over-charged. In addition, the pixel cells farther away from the gate IC may not be able to reach the designated level due to the RC delay such that the levels of the two ends of the pixel cells are different. Thus, the color displayed at one side of the gate IC may be pale.

### SUMMARY

In order to overcome the above problems, the present disclosure relates to a display panel and a LCD for avoiding the pale issue occurring at one side close to the gate IC.

In one aspect, a display panel includes: a plurality of pixel cells comprising thin film transistors (TFTs), wherein W representing a width of a trench within the TFT, and L representing a length of the trench within the TFT; a plurality of data lines and a plurality of scanning lines intersecting with each other to limit locations of the pixel cells; a source driver connecting to the data lines such that the data signals being provided to each of the data lines; a gate driver connecting to the scanning lines such that scanning signals are provided to the scanning lines; and wherein a ratio (W/L) of the width (W) to the length (L) of the trench within the TFTs being configured such that the pixel cells connected by the same scanning line being fully charged at the same time.

Wherein with respect to the pixel cells connected by the same scanning line, along a direction away from the gate driver, the W/L of the TFT of the previous pixel cell is smaller than the W/L of the TFT of the current pixel cell.

Wherein with respect to the pixel cells connected by the same scanning line, along a direction away from the gate driver, the pixel cells are divided into a plurality of groups, the W/L of the TFT of the current pixel cell group is larger than the W/L of the TFT of the previous pixel cell group, and the W/L of the TFTs within the same pixel cell group are the same.

Wherein a ratio of an absolute value of the difference between the W/L of the TFT of the previous pixel cell and the W/L of the TFT of the current pixel cell to the W/L of the current pixel cell is proportional to a ratio of the absolute value of the difference between a charging period of the previous pixel cell and the charging period of the current pixel cell to the charging period of the previous pixel cell.

Wherein a ratio of an absolute value of the difference between the W/L of the TFT of the previous pixel cell group and the W/L of the TFT of the current pixel cell group to the W/L of the current pixel cell group is proportional to a ratio of the absolute value of the difference between the charging period of the previous pixel cell group and the charging period of the current pixel cell group to the charging period of the previous pixel cell group.

Wherein with respect to the pixel cells connected by the same data line, the W/L of the TFTs of each of the pixel cells are the same.

In another aspect, a display device includes: a display panel comprising a plurality of pixel cells comprising thin film transistors (TFTs), wherein W representing a width of a trench within the TFT, and L representing a length of the trench within the TFT; a plurality of data lines and a plurality of scanning lines intersecting with each other to limit locations of the pixel cells; a source driver connecting to the data lines such that the data signals being provided to each of the data lines; a gate driver connecting to the scanning lines such that scanning signals are provided to the scanning lines; and wherein a ratio (W/L) of the width (W) to the length (L) of the trench within the TFTs being configured such that the pixel cells connected by the same scanning line being fully charged at the same time.

In view of the above, the pixel cells connected to the same scanning line may be charged fully at the same time so as to avoid the pale issue occurring at one side close to the gate IC.

### BRIEF DESCRIPTION OF THE DRAWINGS

FIG. 1 is a schematic view of the display panel in accordance with one embodiment.

FIG. 2 is a schematic view showing the length and the width of the trench of the TFT in accordance with one embodiment.

### DETAILED DESCRIPTION OF THE EMBODIMENTS

Various example embodiments will now be described more fully with reference to the accompanying drawings in which some example embodiments are shown. In the drawings, the thicknesses of layers and regions may be exaggerated for clarity. In the following description, in order to avoid the known structure and/or function unnecessary detailed description of the concept of the invention result in confusion, well-known structures may be omitted and/or functions described in unnecessary detail.

In the present disclosure, the LCD may be taken as an example. It is to be noted that the display panel in the present disclosure may be OLED or other display panels other than the LCD as described.

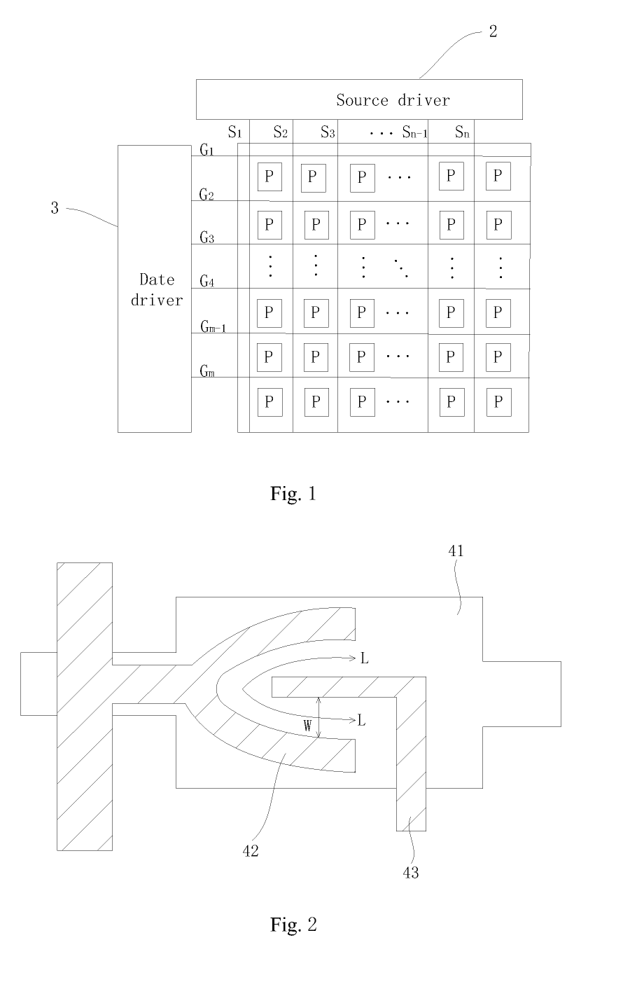

FIG. 1 is a schematic view of the display panel in accordance with one embodiment. FIG. 2 is a schematic view showing the length and the width of the trench of the TFT in accordance with one embodiment.

Referring to FIG. 1, the display panel 1 includes a timing controller (not shown), a source driver 2, a gate driver 3, a plurality of data lines (S₁-Sₙ), a plurality of scanning lines (G₁-Gₘ), and a plurality of pixel cells (P₁₁, . . . , P₁ₙ, . . . , Pₘₙ). It can be understood that the display panel 1 may include other components, such as voltage converter (not shown).

The timing controller provides timing control signals for the second display panel 2 and the gate driver 3 so as to control the operations of the source driver 2 and the gate driver 3.

The source driver 2 connects to the data lines (S₁-Sₙ) such that the data signals are provided to the data lines (S₁-Sₙ) in accordance with the timing control signals provided by the timing controller so as to drive the data lines (S₁-Sₙ), wherein n is an integer.

The gate driver 3 connects to the scanning lines (G₁-Gₘ) such that the scanning signals are provided to the scanning lines (G₁-Gₘ) in accordance with the timing control signals provided by the timing controller so as to drive the scanning lines (G₁-Gₘ), wherein m is an integer.

The data lines (S₁-Sₙ) and the scanning lines (G₁-Gₙ) intersect with each other and are vertical to each other so as to form a m×n matrix.

The number of pixel cells are m×n. Each of the pixel cell (Pᵢⱼ) may be arranged at intersections of the i-th scanning line and the j-th data line. The pixel cell (Pᵢⱼ) includes at least one TFT, a liquid crystal capacitor, and a storage capacitor. A gate of the TFT connects to the i-th scanning line, and a source of the TFT connects to the j-th data line. One ends of the liquid crystal capacitor and the storage capacitor connect to the drain of the TFT, and the other ends of the liquid crystal capacitor and the storage capacitor are grounded.

In one embodiment, along a direction away from the gate driver 3, a W/L ratio of the TFT of the previous pixel cell is smaller than that of the W/L ratio of the TFT of the current pixel cell such that the pixel cells connected by the same scanning line (which means the pixel cell in the same row) may be charged fully at the same time. As shown in FIG. 2, W represents the width of the trench within the TFT, and L represents the length of the trench within the TFT. In addition, the TFT also includes the gate 41, the source 42, and the drain 43.

For instance, with respect to the pixel cell (P₁₁, . . . P₁ₙ), along the direction away from the gate driver 3, the W/L ratio of the TFT of the pixel cell (P₁ⱼ) is smaller than that of the pixel cell (P₁₍ⱼ₊₁) such that the pixel cells in the first row, such as P₁₁, . . . P₁ₙ, may be charged fully at the same time, wherein (1≦j≦n).

In addition, with respect to the pixel cells in each rows, along the direction away from the gate driver 3, an absolute value of the difference between the W/L of the TFT of the previous pixel cell and the W/L of the TFT of the current pixel cell to the W/L of the current pixel cell is proportional to a ratio of the absolute value of the difference between the charging period of the previous pixel cell and the charging period of the current pixel cell to the charging period of the previous pixel cell.

For instance, with respect to the pixel cells in the first row, i.e., P₁₁, . . . P₁ₙ, along the direction away from the gate driver 3, a ratio of an absolute value of the difference between the (W/L)_{P1j} of the previous pixel cell (_{P1(j+1)}) and the (W/L)_{P1(j+1)} of the current pixel cell (_{P1j}) to the (W/L)_{P1(j+1}) of the current pixel cell (_{P1j}), which may be represented as |(W/L)_{P1j}−(W/L)_{P1(j+1)}|/(W/L)_{P1(j+1)}, is proportional to a ratio of the absolute value of the difference between the charging period (T_{P1j}) of the previous pixel cell (P₁ⱼ) and the charging period (T_{P1(j+1)}) of the current pixel cell (P₁₍ⱼ₊₁₎), which may be represented as |T_{P1j}−T_{P1(j+1)}|, to the charging period (T_{P1j}) of the current pixel cell (P₁ⱼ), which may be represented as |T_{P1j}−T_{P1(j+1})|/T_{P1j}. That is, the equation below is satisfied:

|(W/L)_{P1j}−(W/L)_{P1(j+1)}|/(W/L)_{P1(j+1)}|=a×|T_{P1j}−T_{P1(j+1})|/T_{P1j},

wherein a is a proportional coefficient.

With respect to the pixel cells in the same column (which means the pixel cells connected by the same data line), the W/L of the TFTs of each of the pixel cells are the same. For instance, the W/L of the TFTs of each of the pixel cells (Pᵢ₁) among the pixel cells (P₁₁, . . . , Pₘ₁) in the first column are the same.

In the embodiment, with respect to the pixel cells in the same row, along the direction away from the gate driver 3, the pixel cells in each of the rows are divided to a plurality of groups. The W/L of the TFT of the current pixel cell group is larger than that of the previous pixel cell group. In addition, the W/L of the TFTs within the same pixel cell group are the same such that the pixel cells connected by the same scanning line, which means the pixel cells in the same row) may be charged fully at the same time. As shown in FIG. 2, W represents the width of the trench within the TFT, and L represents the length of the trench within the TFT. In addition, the TFT also includes the gate 41, the source 42, and the drain 43.

For instance, with respect to the pixel cell (P₁₁, . . . P₁ₙ), along the direction away from the gate driver 3, the pixel cell may be divided into n/q number of groups, wherein q may be divisible by q. The W/L of the TFTs of the current pixel cell group (P_{1(n-q+1)}, . . . P₁ₙ) is larger than the W/L of the TFTs of the previous pixel cell group (P_{1(n-2q+2)}, . . . P_{1(n-q+1)}). In addition, the W/L of the TFTs of the pixel cells within the same pixel cell group, such as the pixel cells (P_{1(n-q+1)}, . . . P₁ₙ) in the current pixel cell group or in the previous pixel cell group P_{1(n-2q+2)}, . . . P_{1(n-q+1)}), are the same such that the pixel cells (P₁₁, . . . P₁ₙ) in the first row may be charged fully at the same time, wherein (1≦j≦n).

Further, along the direction away from the gate driver 3, an absolute value of the difference between the W/L of the TFT of the previous pixel cell group and the W/L of the TFT of the current pixel cell group to the W/L of the current pixel cell group is proportional to a ratio of the absolute value of the difference between the charging period of the previous pixel cell group and the charging period of the current pixel cell group to the charging period of the previous pixel cell group.

For instance, a ratio of an absolute value of the difference between the (W/L) _{(n/q)-1} of the pixel cells (P_{1(n-2q+2)}, . . . P_{1(n-q+1)}) of the ((n/q)−1)-th pixel cell group and the (W/L) _{n/q} of the pixel cells (P_{1(n-q+1)}, . . . P₁ₙ) of the (n/q)-th pixel cell group, which may be represented as |(W/L)_{(n/q)-1}−(W/L)_{n/q}|, to the (W/L)_{n/q} of the pixel cells (P_{1(n-q+1)}, . . . P₁ₙ) of the (n/q)-th pixel cell group, which may be represented as |(W/L)_{(n/q)-1}−(W/L)_{n/q}|/(W/L)_{n/q}, is proportional to a ratio of the absolute value of the difference between the charging period (T_{(n/q)-1}) of the pixel cells (P_{1(n-2q+2)}, . . . P_{1(n-q+1)}) of the ((n/q)−1)-th pixel cell group and the charging period (T_{n/q}) of the pixel cells (P_{1(n-q+1)}, . . . P₁ₙ) of the (n/q)-th group, which may be represented as |T_{(n/q)-1}−T_{n/q}|, to the charging period (T_{n/q-1}) of the pixel cells (P_{1(n-2q+2)}, . . . P_{1(n-q+1)}) of the ((n/q)−1)-th group, which may be represented as |T_{(n/q)-1}−T_{n/q}|/T_{(n/q)-1j}. That is, the equation below is satisfied:

|(W/L)_{(n/q)-1}−(W/L)_{n/q}|/(W/L)_{n/q}=b×|T_{(n/q)-1}−T_{n/q}|/T_{(n/q)-1},

wherein b is a proportional coefficient.

With respect to the pixel cells in the same column (which means the pixel cells connected by the same data line), the W/L of the TFTs of each of the pixel cells are the same. For instance, the W/L of the TFTs of each of the pixel cells (Pᵢ₁) among the pixel cells (P₁₁, . . . , Pₘ₁) in the first column are the same.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A display panel, comprising:
a plurality of pixel cells comprising thin film transistors (TFTs), wherein W representing a width of a trench within the TFT, and L representing a length of the trench within the TFT;
a plurality of data lines and a plurality of scanning lines intersecting with each other to limit locations of the pixel cells;
a source driver connecting to the data lines such that the data signals being provided to each of the data lines;
a gate driver connecting to the scanning lines such that scanning signals are provided to the scanning lines; and
wherein a ratio (W/L) of the width (W) to the length (L) of the trench within the TFTs being configured such that the pixel cells connected by the same scanning line being fully charged at the same time.

2. The display panel as claimed in claim 1, wherein with respect to the pixel cells connected by the same scanning line, along a direction away from the gate driver, the W/L of the TFT of the previous pixel cell is smaller than the W/L of the TFT of the current pixel cell.

3. The display panel as claimed in claim 1, wherein with respect to the pixel cells connected by the same scanning line, along a direction away from the gate driver, the pixel cells are divided into a plurality of groups, the W/L of the TFT of the current pixel cell group is larger than the W/L of the TFT of the previous pixel cell group, and the W/L of the TFTs within the same pixel cell group are the same.

4. The display panel as claimed in claim 2, wherein a ratio of an absolute value of the difference between the W/L of the TFT of the previous pixel cell and the W/L of the TFT of the current pixel cell to the W/L of the current pixel cell is proportional to a ratio of an absolute value of the difference between a charging period of the previous pixel cell and the charging period of the current pixel cell to the charging period of the previous pixel cell.

5. The display panel as claimed in claim 3, wherein a ratio of an absolute value of the difference between the W/L of the TFT of the previous pixel cell group and the W/L of the TFT of the current pixel cell group to the W/L of the current pixel cell group is proportional to a ratio of an absolute value of the difference between the charging period of the previous pixel cell group and the charging period of the current pixel cell group to the charging period of the previous pixel cell group.

6. The display panel as claimed in claim 1, wherein with respect to the pixel cells connected by the same data line, the W/L of the TFTs of each of the pixel cells are the same.

7. The display panel as claimed in claim 2, wherein with respect to the pixel cells connected by the same data line, the W/L of the TFTs of each of the pixel cells are the same.

8. The display panel as claimed in claim 3, wherein with respect to the pixel cells connected by the same data line, the W/L of the TFTs of each of the pixel cells are the same.

9. The display panel as claimed in claim 4, wherein with respect to the pixel cells connected by the same data line, the W/L of the TFTs of each of the pixel cells are the same.

10. The display panel as claimed in claim 5, wherein with respect to the pixel cells connected by the same data line, the W/L of the TFTs of each of the pixel cells are the same.

11. A display device, comprising:
a display panel comprising a plurality of pixel cells comprising thin film transistors (TFTs), wherein W representing a width of a trench within the TFT, and L representing a length of the trench within the TFT;
a plurality of data lines and a plurality of scanning lines intersecting with each other to limit locations of the pixel cells;
a source driver connecting to the data lines such that the data signals being provided to each of the data lines;
a gate driver connecting to the scanning lines such that scanning signals are provided to the scanning lines; and
wherein a ratio (W/L) of the width (W) to the length (L) of the trench within the TFTs being configured such that the pixel cells connected by the same scanning line being fully charged at the same time.
